(19) United States
(12) Patent Application Publication
(10) Pub. No.: US 2012/0056400 A1
(43) Pub. Date: Mar. 8, 2012

(54) TRICYCLE CONVERSION ASSEMBLY FOR A MOTORCYCLE

(76) Inventors: John St Clair, (US); Stephen Hussey, (US)

(21) Appl. No.: 12/877,640

(22) Filed: Sep. 8, 2010

(51) Int. Cl. B62K 13/04

(52) U.S. Cl. 280/282

(57) ABSTRACT

A tricycle conversion assembly for a motorcycle comprising two bilaterally symmetrical stabilizers independently mounted to and suspended from a motorcycle frame by adjustable means of attachment. The stabilizers dispose auxiliary wheels essentially even with and parallel to the motorcycle rear wheel wherein the adjustable means of attachment suspend the stabilizers from the motorcycle without moving parts and provide for modifying the alignment of the stabilizers with the motorcycle and for modifying the reactivity of the stabilizers with variations in the ground surface. The assembly provides the opportunity to replace a stabilizer with a side car, and for attachment of an optional towing crossbar at the rear of the assembly.

### CROSS-REFERENCE TO RELATED APPLICATIONS

Not applicable

### STATEMENT REGARDING FEDERALLY FUNDED RESEARCH OR DEVELOPMENT

Not applicable

### REFERENCE TO SEQUENCE LISTING, A TABLE, OR COMPUTER PROGRAM LISTING Not applicable

### BACKGROUND OF THE INVENTION

Prior art the inventors are aware of includes the following:

U.S. Pat. No. 6,739,420 for an auxiliary wheel conversion assembly for a motorcycle

U.S. Pat. No. 5,529,141 for a kit for converting a motorcycle to a tricycle

U.S. Pat. No. 5,499,689 for a motorcycle conversion rear axle mounting system

U.S. Pat No. 5,518,259 movable powered outriggers

U.S. Pat. No. 4,697,659 for a vehicle fraction attachment

U.S. Pat. No. 4,287,960 for a motorcycle conversion kit

U.S. Pat. No. 4,133,402 for a two wheel motorized vehicle side wheel outrigger assembly

U.S. Pat. No. 3,767,000 for a motorcycle with auxiliary wheel

U.S. Pat. No. 3,419,098 for a three wheeled automotive vehicle

U.S. Pat. No. 2,889,891 for auxiliary wheel supports for vehicles

U.S. Pat. No. 1,956,319 for a convertible motorcycle chassis

U.S. Pat. No. 1,933,102 for a motor tricycle

U.S. Pat. No. 1,279,070 for a tractor attachment

U.S. Pat. No. 1,152,821 for a motor vehicle

Tricycle conversions for motorcycles as described in the referenced prior art suffer from a number of issues, with the most common being reliance upon a u-shaped frame, and reliance upon the suspension and shock absorbers of the motorcycle for mounting of and ride control of the attached assemblies. Other problems with the prior art are the complexity and weight of the apparatus, the need to permanently modify the motorcycle, and the expense of the apparatus. The present invention presents a new and unique approach to tricycle conversions for motorcycles by utilizing two independently mounted and suspended stabilizers that dispose auxiliary wheels on either side of a motorcycle rear wheel as outriggers to bias the vehicle toward an upright position, wherein the current invention is simple in design and manufacture, lightweight, easy to attach to and detach from a motorcycle, inexpensive to manufacture, and does not require permanent modification of the motorcycle.

### SUMMARY OF THE INVENTION

The current invention is an assembly which disposes two independently suspended, bilaterally symmetrical stabilizers on opposite sides of a motorcycle, with each stabilizer featuring in combination an axle, hub, and wheel mounted to a predetermined outside rear area of the stabilizer, so that when the tricycle conversion assembly is properly attached to the motorcycle the stabilizer wheels are positioned as outriggers to bias the motorcycle toward an upright position.

The inventors' preferred embodiment of this invention is an assembly comprising two connection crossbars securely and laterally affixed to the underside of a motorcycle frame, with one crossbar generally positioned as far forward on the frame as possible for secure and aesthetic attachment, and the second crossbar affixed to the underside of the frame at a predetermined distance and location rearward of the first crossbar, typically between twelve and twenty inches according to the physical characteristics of the vehicle being converted. Due to the wide variety of motorcycle configurations, the exact positioning and method of affixing to the connection crossbars to the motorcycle frame will be determined by those practiced in the art and does not fall under the scope of this invention.

Each connection crossbar extends outward a predetermined and essentially equal distance on either side of the motorcycle, providing two mounting holes near each end of each connection crossbar, resulting in four attachment sites on each side of the motorcycle, two forward and two rearward. Each stabilizer frame features a forward extending rail providing a predetermined forward and a rearward mounting area, with each mounting area having an inside hole and an outside hole. Each stabilizer frame thereby presents four mounting locations to facilitate proper attachment of the stabilizer to the connection crossbars on one side of the motorcycle.

Secure and adjustable connection of the stabilizers to the connection crossbars is accomplished with bolts, nuts, washers, and shock absorbing bushings, wherein at each mounting location a bushing is placed between the connection crossbar and stabilizer rail and interlaced with washers in a predetermined combination, wherein a bolt passes through the stabilizer rail, bushing, connection crossbar, and interlaced washers to screw into a nut, resulting in secure and cushioned attachment of the stabilizer to the connection crossbar.

Adjustment of the bolts and nuts changes the distance separating the stabilizer and the connection crossbar, as well as the degree to which the shock absorbing bushing is compressed, creating two important features of the current invention, ride adjustment and wheel alignment. Modifying the compression of the bushings changes the amount of play and flexibility between the stabilizer and the crossbar, thereby adjusting the reactivity of the stabilizer to the ground surface, or ride stiffness. Additionally, selective modification of bushing compression across the four points of attachment changes the angles of attachment, allowing for alignment of the stabilizer.

The unique method of attaching the stabilizers to the motorcycle as proposed by this invention results in a tricycle type vehicle wherein the stabilizers of the assembly are individually suspended without the use of moving parts.

### BRIEF DESCRIPTION OF THE DRAWINGS

FIG. 1 is a plan view of the inventive tricycle conversion assembly for a motorcycle.

FIG. 2 is a front elevation view detail to illustrate the interlacing of the cooperative connective members of the assembly with the adjustable means of attachment.

FIG. 3 is a plan view of the frame of the right side bilaterally symmetrical stabilizer.

FIG. 4 is a side elevation view of the right side bilaterally symmetrical stabilizer.

FIG. 5 is a rear elevation view of the frame of the right side bilaterally symmetrical stabilizer.

FIG. 6 is a perspective view of the optional towing crossbar.

FIG. 7 is sectional perspective view of the extreme rear end of the forward extending rail featuring a means of attachment for the optional towing crossbar.

FIG. 8 is a plan view of the tricycle conversion assembly for a motorcycle with the optional towing crossbar attached to tricycle conversion assembly.

FIG. 9 is a side elevation view of a motorcycle indicating common attachment positions of the connection crossbars to the motorcycle frame.

FIG. 10 is a side elevation view of the adjustable means of attachment.

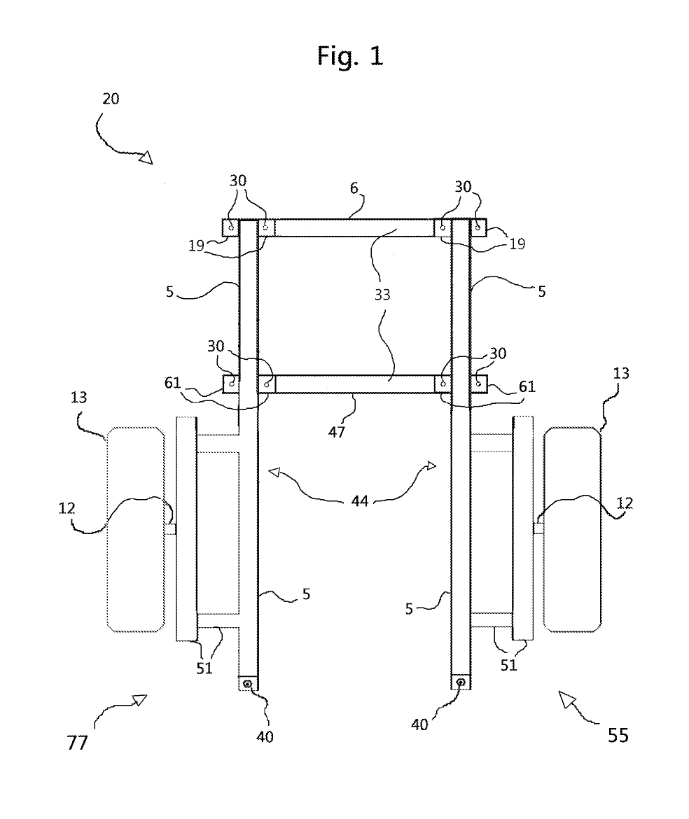

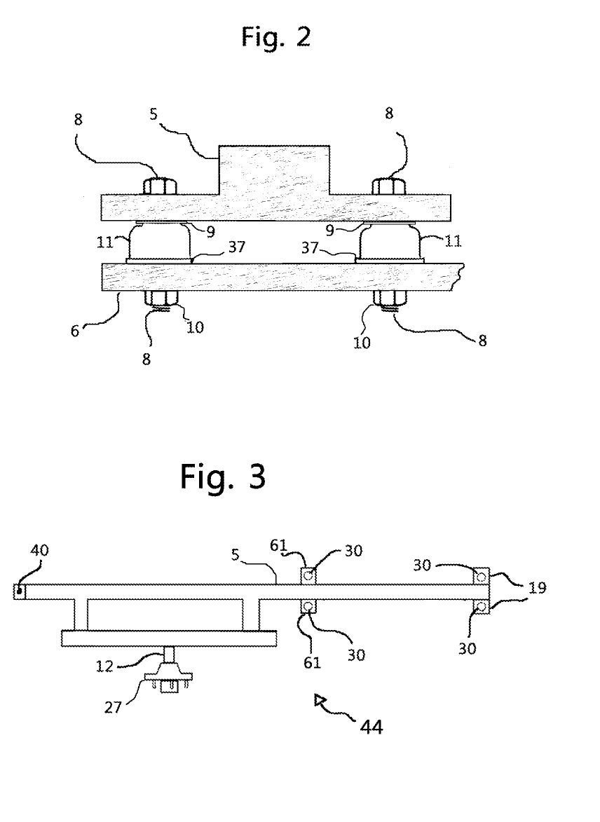

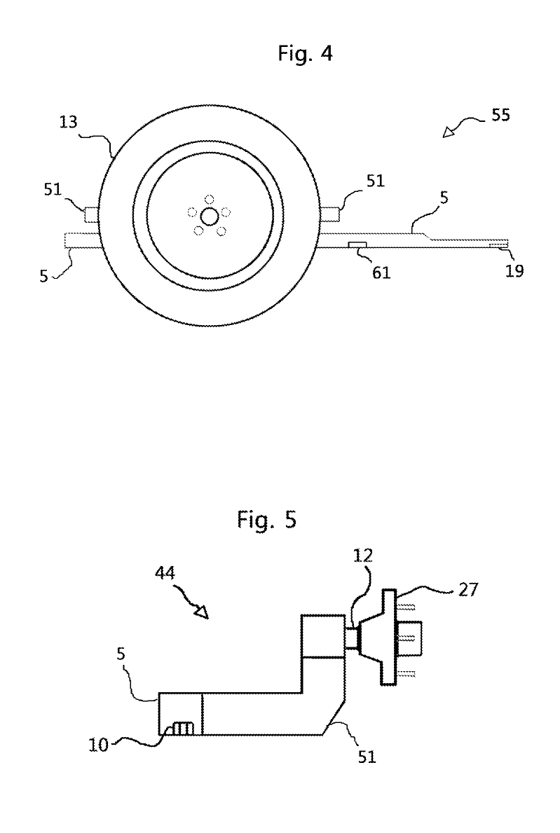

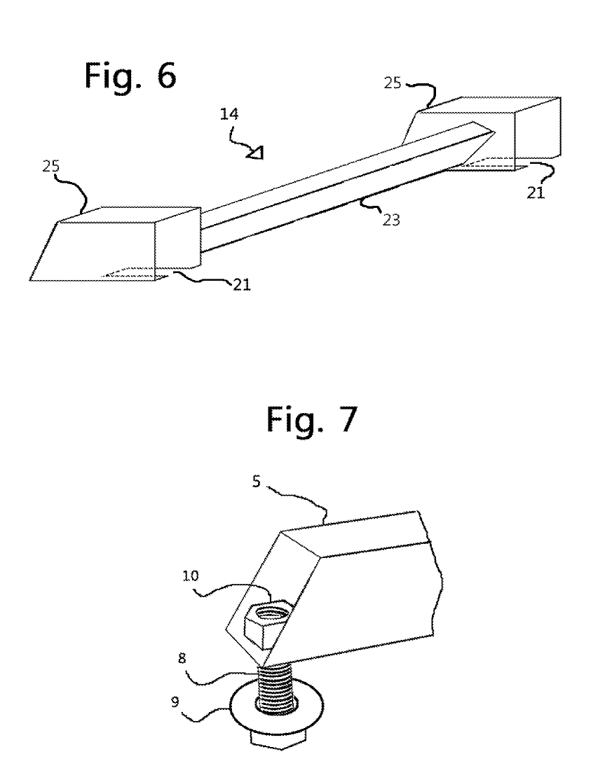

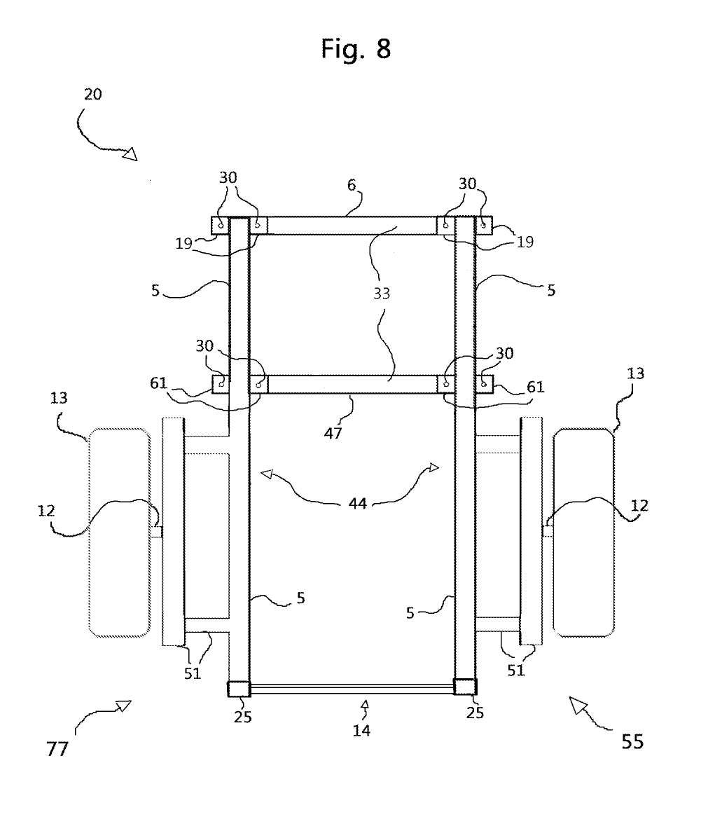

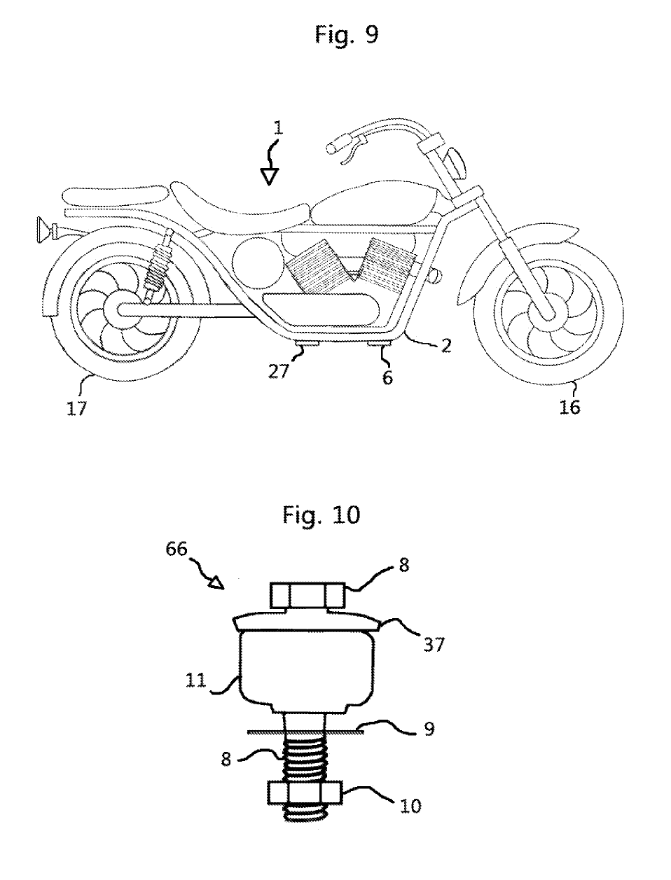

### DETAILED DESCRIPTION OF THE INVENTION

The present invention is a tricycle conversion assembly 20 for a motorcycle 1, comprising a front connection crossbar 6, a rear connection crossbar 47, a right stabilizer 55, a left stabilizer 77, and adjustable means of attachment 66 to securely connect the assembly 20.

The right 55 and left 77 stabilizers are bilaterally symmetrical and feature a frame 44 of predetermined length to extend from the front connection crossbar 6 to a point beyond the circumference of the rear wheel 17 of a motorcycle 1, with each frame 44 featuring a forward extending rail 5 and a side frame 51. At the extreme forward end of the rail 5, a first pair of mounting flanges 19 are disposed opposite of each other on either side of and perpendicular to and extending beyond either side of the rail 5 a predetermined distance, wherein mounting holes 30 are drilled in the mounting flanges 19 to accommodate the incorporation of the adjustable means of attachment 66. A second pair of mounting flanges 61 are similarly disposed on the rail 5 at a predetermined distance rearward of the first pair 19. The extreme rear end of the forward extending rail 5 features an opening wherein a nut 10 is welded to the inside of the rail 5 to provide a site of attachment 40 for removably connecting an optional towing crossbar 14. Additionally, each stabilizer frame 44 features a side frame 51 affixed to the outside of the forward extending rail 5 at a predetermined distance rearward of the second pair of mounting flanges 61 to provide for incorporating an axle 12 and hub 27.

The front connection crossbar 6 and the rear connection crossbar 47 are securely connectable in a manner predetermined by those practiced in the art to the underside of a motorcycle frame 2 and extend on either side of the motorcycle 1 beyond the frame 2 a predetermined distance, with mounting holes 30 drilled in predetermined locations near the ends of crossbars 6 and 47 for securely connecting stabilizers 55 and 77 to crossbars 6 and 47 with adjustable means of attachment 66.

Comprising a bolt 8, a nut 10, a flat washer 9, a bushing washer 37, and a shock absorbing bushing 11, the adjustable means of attachment 66 provide for modifiable connectivity between the connection crossbars 6 and 47, and the stabilizers 55 and 77.

An optional towing crossbar 14 comprising a structural element 23 and two endcaps 25 wherein the endcaps 25 have receiving slots 21 cut into their undersides, is removably connectable to the tricycle conversion assembly 20 at an attachment site 40 located at the extreme rear end of forward extending rail 5.

In the preferred embodiment, the front 6 and rear 47 connection crossbars are removably affixed to the frame 2 of a motorcycle 1 to maintain the original nature of the vehicle. Due to the variety and complexity presented by the numerous motorcycle designs in the field, the procedure for secure attachment of the tricycle conversion assembly 20 to a motorcycle 1 does not fall within the scope of this invention. The connection crossbars 6 and 47 in the drawings present fields of attachment 33 in between the mounting holes 30 that provide places for drilling holes, affixing brackets, and other means of connectivity that may be utilized by those practiced in the art for securely connecting crossbars 6 and 47 to the motorcycle frame 2. The inventors are aware that considerable variation in the configuration of connection crossbar attachment is expected and that variability has no bearing on the validity of this patent.

Upon affixing connection crossbars 6 and 47 to the motorcycle frame 2, the mounting holes 30 on the ends of connection crossbars 6 and 47 are positioned opposite each other outside of the motorcycle frame 2 in predetermined locations to correspond to the positions of the mounting holes 30 of the front 19 and rear 61 mounting flanges of the forward extending rail 5 of the stabilizer frame 44, resulting in four sets of corresponding mounting sites on either side of the motorcycle 1 for connecting stabilizers 55 and 77 to the connection crossbars 6 and 47 using the adjustable means of attachment 66, wherein a bolt 8 is passed through a stabilizer frame 44 mounting hole 30, a bushing washer 37, a shock absorbing bushing 11, a flat washer 9, a mounting hole 30 in connection crossbar 6 or 47, and into a nut 8. Connection of stabilizers 55 and 77 to the connection crossbars with the adjustable means of attachment 66 does thereby suspend stabilizers 55 and 77 from the motorcycle 1 without moving parts.

Modification of the adjustable means of attachment 66 has two primary effects. Tightening the connection compresses the shock absorbing bushing 11, decreasing its flexibility, providing means of adjusting the reactivity of stabilizers 55 and 77 to variations in a ground surface. Additionally, stabilizer 55 and 77 in cooperative connection with connection crossbars 6 and 47 offer four sites of adjustable connectivity for each stabilizer, affording independent modification in the angles of connectivity of each stabilizer, whereby stabilizers 55 and 77 are provided with independent means of aligning stabilizers 55 and 77 with the motorcycle and means of adjusting the suspension of stabilizers 55 and 77.

Comprising a forward extending rail 5, and a side frame 51 with an attached axle 12 and a hub 27, a stabilizer frame 44 provides for disposing a wheel 13 in a predetermined position as an outrigger rotationally parallel to and essentially even with the rear wheel 17 of the motorcycle 1 to bias the motorcycle 1 towards an upright position. Stabilizers 55 and 77 in conjunction with connection crossbars 6 and 47, and with adjustable means of attachment 66 thereby present an inventive tricycle conversion assembly 20 wherein all wheels are independently suspended on a tricycle type vehicle biased towards an upright position.

We claim:

1. A tricycle conversion assembly for a motorcycle, wherein said motorcycle is an inline two wheeled vehicle with an independently suspended front wheel and an independently suspended rear wheel that is capable of travel over a ground surface, comprising in combination two connection crossbars, two stabilizers, and adjustable means of attachment, wherein said connection crossbars are independently and securely connectable to a frame of the motorcycle essentially parallel to one another and essentially perpendicular to the inline axis of said two wheels, wherein said two stabilizers are independently connectable to the connection crossbars by said adjustable means of attachment, wherein the adjustable means of attachment provide each stabilizer with independent suspension free of moving parts, wherein the stabilizers dispose auxiliary wheels as outriggers essentially even with and rotationally parallel to said rear wheel of the motorcycle, wherein the adjustable means of attachment provide for modification in alignment of the stabilizers with the motorcycle, wherein the adjustable means of attachment provide for modifying reactivity of the stabilizers to variations in said ground surface, whereby attachment of said tricycle conversion assembly to the motorcycle in a predetermined manner results in a tricycle type vehicle biased toward an upright position wherein all wheels of said tricycle type vehicle are independently suspended.

2. A tricycle conversion assembly for a motorcycle as in claim 1, wherein one stabilizer is removable to provide for attachment of a sidecar, wherein said sidecar replaces said removed stabilizer as an outrigger, maintaining the bias of the motorcycle toward an upright position.

3. A tricycle conversion assembly for a motorcycle as in claim 1, wherein the stabilizers have a front end and a rear end, wherein said rear ends of the stabilizers extend beyond the outside diameter of the rear wheel of the motorcycle, providing for secure and removable attachment of an optional towing crossbar to the stabilizers in a predetermined manner, wherein said optional towing crossbar provides for secure attachment of a trailer hitch.

4. A tricycle conversion assembly for a motorcycle with means of suspending stabilizers from said motorcycle without moving parts, wherein said stabilizers dispose auxiliary wheels as outriggers to bias the motorcycle toward an upright position.
